(19) United States
(12) Patent Application Publication
(10) Pub. No.: US 2008/0108321 A1
(43) Pub. Date: May 8, 2008

(54) Over-the-air (OTA) device provisioning in broadband wireless networks

(76) Inventors: Pouya Taaghol, San Jose, CA (US); Muthaiah Venkatachalam, Beaverton, OR (US)

Correspondence Address: INTEL CORPORATION;c/o INTELLEVATE, LLC, P.O. BOX 52050, MINNEAPOLIS, MN, 55402, US

(21) Appl. No.: 11/648,177

(22) Filed: Dec. 29, 2006

Related U.S. Application Data
(60) Provisional application No. 60/858,195, filed on Nov. 8, 2006.

(51) Int. Cl. H04M 1/66

(52) U.S. Cl. 455/410

(57) ABSTRACT

Embodiments of the invention pertain to methods and systems for providing over-the-air provisioning to newly activate mobile station in a broadband wireless access (BWA) network. In one implementation, a newly activated mobile station accessing the BWA network will be checked for hardware compliance certification via a certificate authority. If the device is compliant certified and not yet provisioned for use in the network, the device will be hotlined to a provisioning server for subscriber activation via its OTA link with the BWA network. Additional variants and embodiments are also disclosed.

### CROSS-REFERENCE TO RELATED APPLICATIONS

This application claims priority under 35 U.S.C. §119e to co-pending U.S. application Ser. No. 60/858,195 entitled “Over-the-air (OTA) Device Provisioning In Broadband Wireless Networks” and filed by the instant inventors on Nov. 8, 2006.

### BACKGROUND OF THE INVENTION

There is ongoing interest in developing and deploying mobile networks which may facilitate transfer of information at broadband rates. These networks are colloquially referred to herein as broadband wireless access (BWA) networks and may include networks operating in conformance with one or more protocols specified by the 3^{rd} Generation Partnership Project (3GPP) and its derivatives or the Institute for Electrical and Electronic Engineers (IEEE) 802.16 standards (e.g., IEEE 802.16-2005), although the embodiments discussed herein are not necessarily so limited. IEEE 802.16 compliant BWA networks are sometimes referred to as WiMAX networks, an acronym that stands for Worldwide Interoperability for Microwave Access, which is a certification mark for products that pass conformity and interoperability tests for the IEEE 802.16 standards.

It is predicted that many different device types may be enabled by mobile broadband wireless technologies. Such devices may include notebooks, ultra mobile PC (UMPC), and other consumer electronics such as MP3 players, digital cameras, etc. A mobile broadband service provider would therefore require a dynamic over-the-air (OTA) provisioning solution to activate and enable subscriptions for all these device types.

### BRIEF DESCRIPTION OF THE DRAWING

Aspects, features and advantages of the present invention will become apparent from the following description of the invention in reference to the appended drawing in which like numerals denote like elements and in which:

FIG. 1 is a block diagram for an Over-The-Air (OTA) Provisioning Network Architecture according to various embodiments of the invention;

FIG. 2 is a flow diagram for OTA Provisioning according to another aspect of the invention;

FIG. 3 is a signaling diagram for MS-Triggered Provisioning according to further aspects of the invention;

FIG. 4 is a signaling diagram for Network-Triggered Provisioning according to various aspects of the invention;

FIG. 5 is a flow diagram for a Device Locking Process according to yet another aspect of the invention; and

FIG. 6 is a flow diagram for a Subscriber Locking Process according to various embodiments;

### DETAILED DESCRIPTION OF THE INVENTION

While the following detailed description may describe example embodiments of the present invention in relation to wireless networks utilizing orthogonal frequency division multiplexing (OFDM) or Orthogonal Frequency Division Multiple Access (OFDMA) modulation, the embodiments of present invention are not limited thereto and, for example, can be implemented using other multi-carrier or single carrier spread spectrum techniques such as direct sequence spread spectrum (DSSS), frequency hopping spread spectrum (FHSS), code division multiple access (CDMA) and others. While example embodiments are described herein in relation to broadband wireless access for wireless metropolitan area networks (WMANs) such as WiMAX networks, the invention is not limited thereto and can be applied to other types of wireless networks where similar advantages may be obtained. Such networks specifically include, but are not limited to, wireless local area networks (WLANs), wireless personal area networks (WPANs) and/or wireless wide area networks (WWANs) such as cellular networks and the like.

The following inventive embodiments may be used in a variety of applications including transmitters and receivers of a mobile wireless radio system. Radio systems specifically included within the scope of the present invention include, but are not limited to, network interface cards (NICs), network adaptors, base stations, access points (APs), gateways, bridges, hubs and satellite radiotelephones. Further, the radio systems within the scope of the invention may include satellite systems, personal communication systems (PCS), two-way radio systems, global positioning systems (GPS), two-way pagers, personal computers (PCs) and related peripherals, personal digital assistants (PDAs), personal computing accessories and all existing and future arising systems which may be related in nature and to which the principles of the inventive embodiments could be suitably applied.

In conventional cellular communication models, a communication device (e.g. a cell phone or network interface card (NIC)) is typically manufactured for a specific service provider (SP), which in turn sells the device to end users. Service providers operate network infrastructure and provide wireless access to subscribers. At the time of sale, a device is typically set up for accessing the service provider's network, which is referred to as “provisioning.” This conventional model is thus predicated on the service provider's control of manufactured equipment which may be used in its wireless network(s) as well as provisioning these devices for the user at the point of sale (POS).

However, in anticipation of many different types of equipment, such as those mentioned previously, being used in broadband wireless access (BWA) networks (such as WiMAX networks) a service provider is less likely to have complete control over the manufacture of all devices which may potentially be used in its BWA network. Furthermore, since this wide variety of devices may be made available by many different vendors a POS provisioning approach may not be adequate. Accordingly, a dynamic over-the-air (OTA) provisioning approach is likely needed to enable these devices to communicate over a service provider's BWA network. Accordingly, embodiments of the present invention propose solutions for dynamic OTA provisioning suitable for various device types (e.g., with or w/o keyboard, universal integrated circuit card (UICC), etc.) to be used in BWA networks. Embodiments of the present invention preferably utilize BWA device technology which is certified by a standardizing body such as the WiMAX Forum Networking Group although the invention is not so limited. Two key issues for service provider's providing BWA service may involve: (i) identifying whether a device is compliant with standards and protocols used in its network (referred to as “device certification”) and (ii) identifying whether a user of a BWA-enabled device is authorized (or “provisioned”) to use the service provider's network.

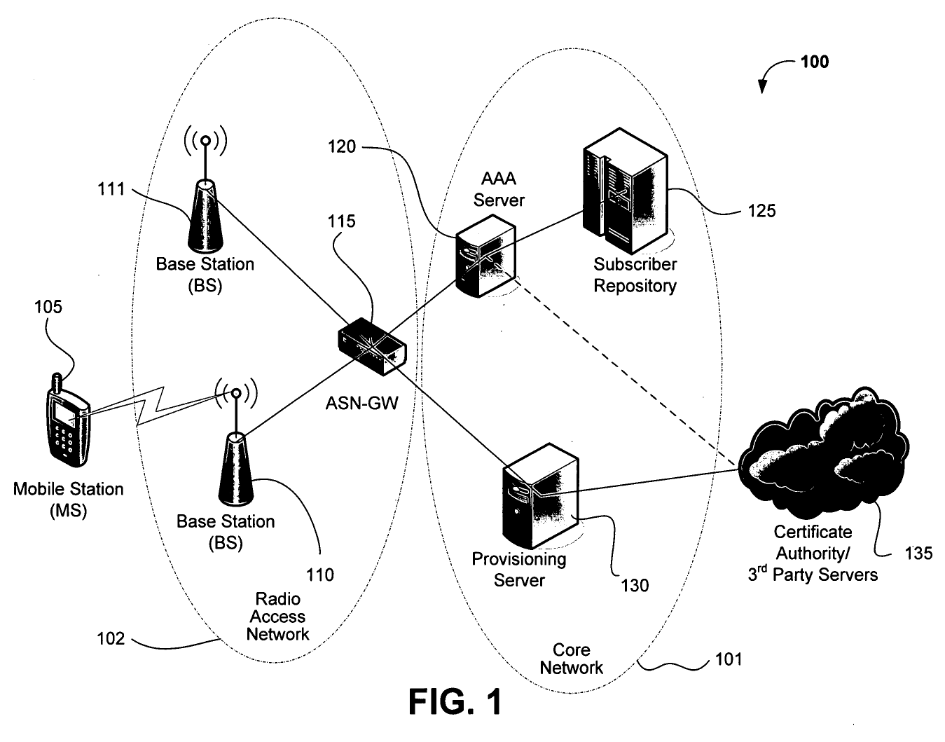

Referring to FIG. 1, according to one exemplary network architecture 100 for BWA OTA provisioning may include a service provider network having a core network 101 and one or more radio access networks (RANs) 102.

A mobile station (MS) 105, for example a subscriber station using protocols compatible with the IEEE) 802.16 standards (e.g., IEEE 802.16-2005 Amendment), may access a service provider's core network 101 via a radio link with a base station (BS) (e.g. BS 110, 111) in the SP's RAN 102. In certain example implementations, communications with MS 105 via RAN 102 may be facilitated via one or more access service network gateways (ASN-GWs) 115 although the inventive embodiments are not limited to this specific type of network implementation. ASN-GW 115 (or other similar type of network node) acts as an interface between the SPs core network 101 and its RANs 102. Thus ASN-GW may be connected to a plurality of base stations 110, 111 and may function as a type of BS controller and/or mobile switching center (MSC) to facilitate handover control and other functions for RAN 102, although the embodiments are not so limited.

In certain embodiments network 100 may further include an authentication, authorization and accounting (AAA) server 120, subscriber repository 125 and provisioning server 130. In certain embodiments subscriber repository 125 may actually comprise one or more entities such as a lightweight directory access protocol (LDAP) server, a home location register (HLR), a home subscriber server (HSS) and/or other entity. An optional billing engine (not shown) may also be included in service provider's core network 101. Network 100 may further include a certificate authority (CA) 135 and/or connections to 3^{rd} party servers for tracking information as explained in more detail in the embodiments below.

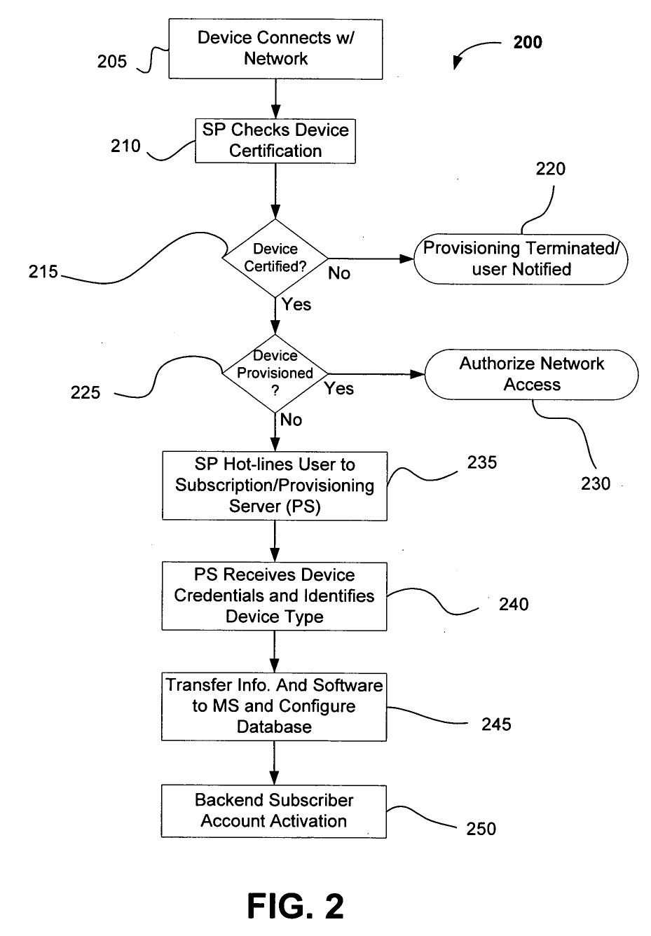

Referring to FIG. 2, an OTA certification and provisioning process 200 will be explained in regard to the example network architecture 100 of FIG. 1. In certain embodiments herein, a non-provisioned device (e.g., MS 105), may attempt to connect 205 with the service provider's network. Initially, the service provider should determine 210, 215 if the device is a certified compliant device. To this end, in one example implementation, at the point of manufacturing (POM), a WiMAX device (e.g., MS 105) may be preset with a medium access control (MAC) address and if it passes a WiMAX Forum or other type of certification process it may also be given a cryptographic digital certificate that is stored in a tamper-resistant device memory in MS 105. A network access identification (NAI) (e.g., MAC@wimax.org) driven from the device MAC address may present the device identity when MS 105 attempts to connect to the service provider's network. This digital certificate may be used to verify (e.g., via certificate authority 135) that the device complies with any required standards. If 215 the device is not a certified device, certification/provisioning process 200 may be terminated 220 and, optionally, the user notified that the device is not certified.

If certificate authority 135 identifies 215 MS 105 as a certified device, the service provider (e.g., via AAA server 120 and subscriber repository 125) may next determine 225 whether MS 105 has been provisioned. If 225 MS 105 has previously been provisioned, network access is authorized 230 and the user may proceed with normal BWA access through the service provider network.

If 225 however, it is determined MS 105 has yet been provisioned, for example AAA server 120 will notice that there is no record of any subscriber for MS 105 in repository 125, AAA server 120 may request ASN Gateway 115, for example via an AAA Accept Message, to hot-line 235 MS 105 to provisioning server 130. AAA server 120 may also allocate an Internet Protocol (IP) address to this non-provisioned device. ASN-GW 115 will then hot-line 235 the device based on the R6 Path ID and device's source IP address. Through the hot-lining process 235, MS 105 is directed to, and only able to access, provisioning server 130.

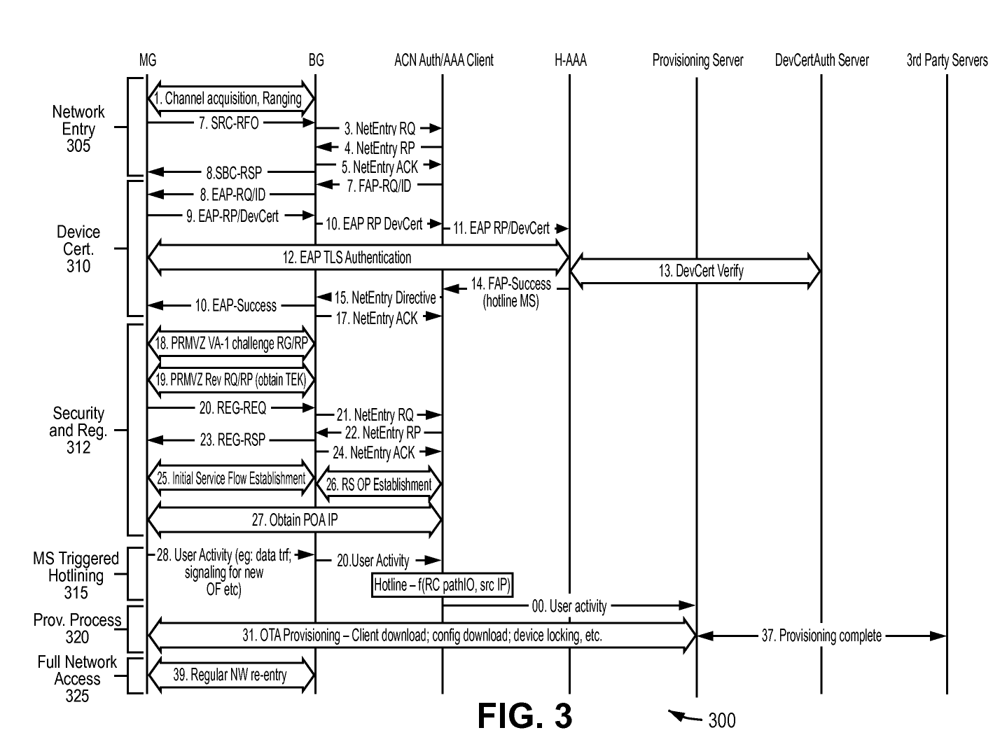

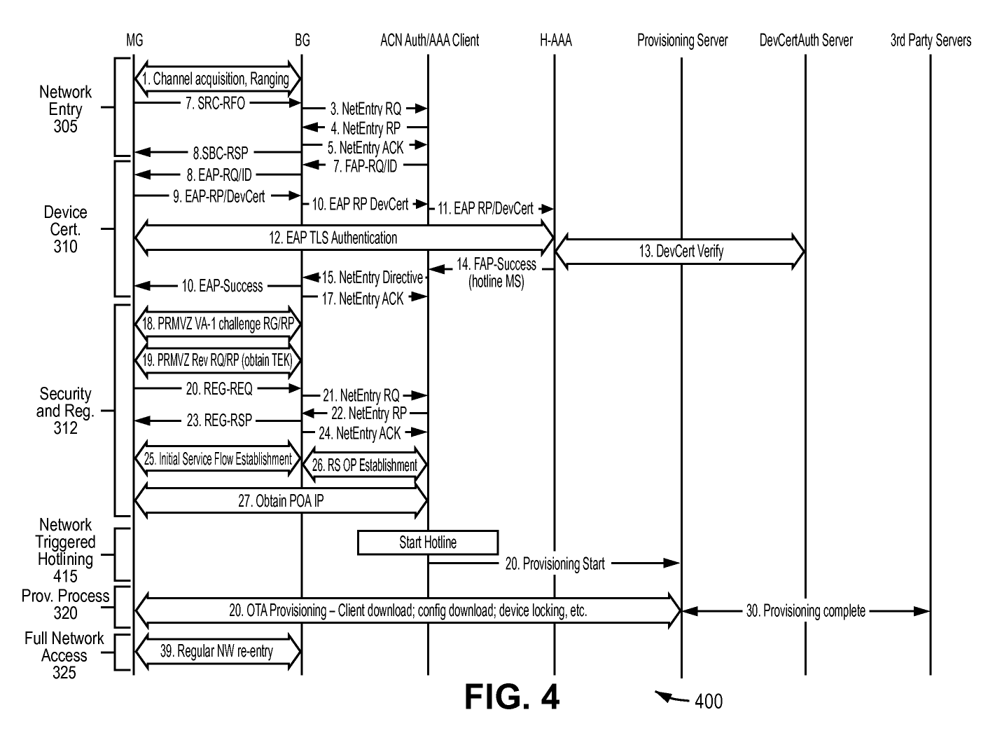

After hot-lining MS 105 to provisioning server 130, a provisioning process e.g., steps 240, 245 can be initiated either by MS 105 (refer to example signaling of FIG. 3) or the network (refer to the example signaling of FIG. 4). The provisioning process allows the subscriber of MS 105 to create an account with the service provider network and may include, among other things, provisioning server 130 receiving 240 device credentials and device identification and an exchange 245 of any other information and/or software with MS 105 which the service provider may deem necessary to activate a subscriber account 250.

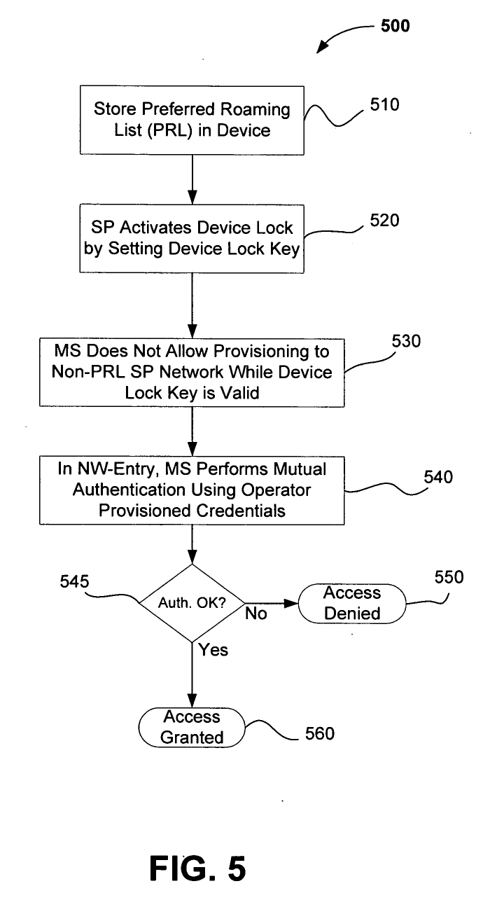

For example, during the provisioning process, various parameters may be exchanged 240, 245 including, but not limited to, platform capability/type, service providers preferred roaming partners list, provisioning agent client download or branding graphic user interface (GUI)) application software downloads (e.g. voice over IP (VoIP), voice on demand (VoD) software), network configuration files (e.g. common management information protocol (CMIP), dynamic host configuration protocol (DHCP)), device lock parameters (referred to in FIG. 5), NAI/password, etc.

During or after the device provisioning process, provisioning server 120 creates and/or activates 250 the new user account in subscriber database(s) (e.g., repository 125) and billing system(s) of the service provider's network. Once MS 105 is provisioned, it may be required to perform device and/or user authentication at the next network re-entry.

In one example implementation, provisioning server 120 may communicate with MS's 105 provisioning agent using simple web browser technology, e.g., simple object access protocol (SOAP)/hyper transfer text protocol secure socket (HTTPS), open mobile alliance device management (OMA-DM) protocols, or other proprietary protocols.

Referring to FIGS. 3 an example signaling process 300 is shown for provisioning a mobile device (e.g., MS 105; FIG. 1) in a broadband wireless access network where the provisioning is triggered by the device. The example of FIG. 3 represents a call flow 300 for provisioning an example device which is minimally pre-provisioned at the POM/ point-of-sale (POS) (for example category-2 and/or category-3 devices).

When a new BWA-enabled device (mobile station-MS) is out of the box and a user tries to access 305 the service provider's wireless network (e.g., WiMAX network), it may perform channel acquisition and initial ranging as in step-1. Next capability negotiations may be exchanged with the BS as in steps 2-6. Upon successful capability negotiations, a device authorization/certification process 310 may be performed. In one example non-limiting embodiment, the network asks the identity of the MS (e.g., using an extensible authentication protocol (EAP) ID request (REQ or RQ) as in steps 7-8). The MS may respond (RSP or RP) with its EAP ID, for example an NAI as discussed above, back to the Authenticator and the home AAA as in steps 9-11. The EAP transport layer security (TLS) authentication of the MS-provided NAI (i.e., device certification) occurs in step 12. In step 13, there may be an optional verification of the MS certification with a 3rd party certificate authority server and/or other 3^{rd} party servers.

Once the device has been certified/authenticated, the home AAA server may realize that the MS is an off the shelf new device trying to connect to the network enforce a hot lining policy for this MS as in step 14. In one embodiment, the hot lining policy enforcement will happen at the authenticator client residing in the ASN-GW and the EAP procedure as shown in steps 15-17 may be completed.

Subsequently, if desired, a data link layer security process, network registration and service flow process 312 may next be performed. In one embodiment using 802.16 (e.g., 802.16-2005 amendment) protocols, a data encryption exchange, as shown in steps 18-19, may occur in which the MS obtains a transport encryption key (TEK) from the BS and in steps 20-24 the MS registers with the network. In steps 25-26, a MAC connection for the initial service flow (e.g., a basic connection identifier (CID)) for the MS may established over the wireless link and in step 27 an IP connection may be established wherein the MS obtains a point-of-attachment (POA) IP address.

In an MS triggered hotlining process 315, if the MS tries to send some traffic to the BS as in step 28 (this could be management traffic or data traffic like traffic to some website), the activity may be trapped at the ASN-GW and the user is hotlined to the provisioning server as in steps 29 and 30. An MS provisioning process 320, similar to that previously discussed may then be performed as shown in step 31. Optionally, provisioning process 320 may include relaying provisioning information (e.g., accounting or registration information) to some 3rd party servers as shown in step 32. In step 33, the fully provisioned MS may be allowed to enter the network again using full network entry procedures 325 in which steps similar to 1-11 may be repeated.

Referring to FIG. 4, a signaling process 400 similar to that of FIG. 3 may alternatively be used in which the hotlining process 415 to the provisioning server is triggered by the network instead of triggered via activity by the mobile station. The specific signaling discussed in reference to FIGS. 3 and 4 are provided merely as examples for specific implementations. Accordingly, other signaling may be used that may vary from that discussed herein which may depend on the type of broadband wireless access network as well as network design preferences.

Turning to FIG. 5, in certain embodiments, a service provider may desire an MS to be locked to the service provider during or after activation/provisioning.

This is referred to herein as device locking. Device locking can be achieved by forcing the device to connect only to the host operator's preferred list of partners or preferred roaming list (PRL). An example device locking process 500 is shown in FIG. 5 and may generally include, during or after the provisioning process(es) discussed above, storing 510 a PRL list in a module of the mobile device and activating 520 device locking by setting a device lock key (which may be performed by the network during provisioning). Thereafter, the device will not allow 530 a user to provision in a service provider network which is not associated with the PRL, at least while the device lock key is valid.

When the device enters the network, the device will perform mutual authentication 540 using operator provisioned credentials. If 545 the credentials are not valid for the network the device is entering, the device will be denied 550 access. If 545 however, the credentials are valid for the network the device is entering, the device will be given 560 access to the network.

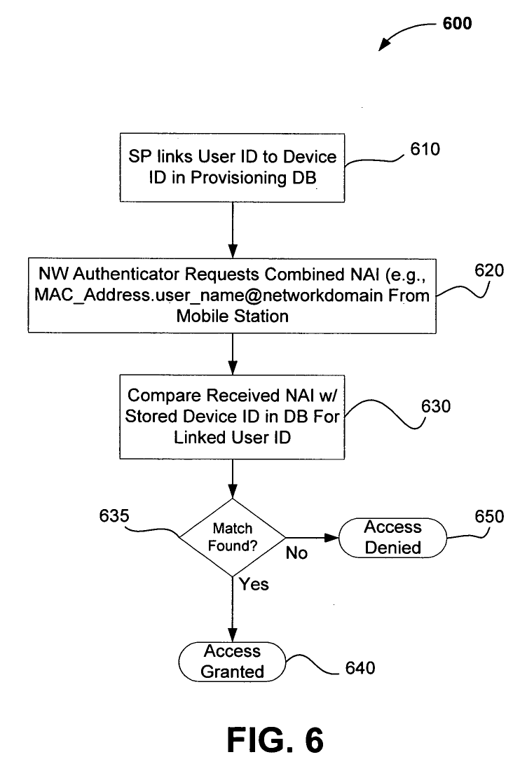

Alternatively or in addition, referring to FIG. 6, a service provider may require a subscriber to be locked to single device after activation. This is referred to herein as “subscriber locking.” In other words, through subscriber locking, a user cannot use its user credentials on other provisioned devices. An exemplary process 600 for subscriber locking can be achieved by linking 610 the user identity to the device identity at the provisioning phase (e.g., 320; FIGS. 3 and 4). In this embodiment, the network access ID (NAI) required from the mobile station for network authentication may be set 620 to include the device identification (e.g., device MAC address) as well as the user identity (e.g., user name). In one example implementation, the NAI used by the mobile station for network access might be similar to “MAC_address.user_name(at)networkdomain.”

The service provider can then verify 630 if the user identity in the received NAI matches the pre-set device identity for this user. In this case, the authentication process only succeeds 640 if 635 the match of user ID and device ID is positive, hence enforcing subscriber locking. If 635 no match is found, the mobile station may be denied 650 access.

Example advantages of the inventive embodiments presented herein may include a device-agnostic solution that can apply to handheld, notebook, ultra mobile PCs (UMPCs) and/or other BWA-enabled consumer electronics. Moreover, the inventive embodiments may allow the use of multiple provisioning protocols including simple web browser access, SOAP/HTTPS, and/or OMA-DM among others. Embodiments of the present invention may allow for provisioning (U)SIM and non-(U)SIM devices and enables non-provisionable devices to be directed to a welcome page for on-off access to host service provider. By using the method(s) and systems of the inventive embodiments, a service provider can seamlessly certify and provision a BWA-enabled device having a generic SKU over-the-air and activate a user account the first time the device connects.

Unless contrary to physical possibility, the inventors envision the embodiments described herein: (i) may be performed in any sequence and/or in any combination; and (ii) the components of respective embodiments may be combined in any manner.

Although there have been described example embodiments of this novel invention, many variations and modifications are possible without departing from the scope of the invention. Accordingly the inventive embodiments are not limited by the specific disclosure above, but rather should be limited only by the scope of the appended claims and their legal equivalents.

The invention claimed is:

1. A method for communicating in a broadband wireless access (BWA) network, the method comprising:
establishing an over-the-air (OTA) connection with a mobile station;
determining whether the mobile station is a device certified to be compliant for use in the BWA network;
determining whether the mobile station has been provisioned to use the BWA network; and
directing the mobile station to a provisioning entity if it is determined the mobile station has not been provisioned.

2. The method of claim 1 wherein determining whether the mobile station is a certified device comprises receiving device identity information from the mobile station via the OTA connection, the device identity information comprising a network access identification (NAI) derived from a medium access control (MAC) address stored in a tamper resistant memory in the mobile station.

3. The method of claim 1 wherein the provisioning entity creates a subscriber account in response to user input at the mobile station via the OTA connection.

4. The method of claim 3 wherein the provisioning entity transfers network configuration files to the mobile station via the OTA connection.

5. The method of claim 1 wherein the BWA network uses protocols compatible with the Institute of Electrical and Electronic Engineers (IEEE) 802.16-2005 standard.

6. The method of claim 1 wherein determining whether the mobile station is certified comprises receiving a device identity via the OTA connection and querying a certificate authority outside the BWA network to identify whether the device identity is valid.

7. The method of claim 1 further comprising denying the mobile station access to the BWA network if it is determined the device not certified.

8. The method of claim 1 further comprising activating a device lock in the mobile station to force the mobile station to be able to connect only to BWA networks authorized by a service provider.

9. The method of claim 1 further comprising linking an identification of the mobile station to a specific user's identification and granting network access only to the specific user in connection with the mobile station.

10. The method of claim 1 wherein directing the mobile station to the provisioning entity is triggered by the mobile station.

11. The method of claim 1 wherein directing the mobile station to the provisioning entity is triggered by the BWA network.

12. A system for communicating in a broadband wireless access (BWA) network, the system comprising:
a network authenticator configured to determine whether a newly connected wireless device has been provisioned for use in the BWA network and, if not, to cause the wireless device to be hotlined to a provisioning server.

13. The system of claim 12 wherein the network authenticator is further configured to determine whether the wireless device is certified as being compliant for use in the BWA network.

14. The system of claim 13 wherein the network authenticator denies network access to the wireless device if it is not compliant certified.

15. The system of claim 13 wherein the network authenticator determines whether the wireless device is certified via an exchange with a certificate authority outside of the BWA network.

16. The system of claim 12 further comprising the provisioning server and wherein the provisioning server is configured to enable a user of the wireless device to activate service with the BWA network via an over-the-air (OTA) connection.

17. The system of claim 12 further comprising a subscriber repository in communication with the network authenticator to identify whether the wireless device has been provisioned.

18. The system of claim 12 further comprising a radio access network (RAN) to facilitate over-the-air (OTA) communication between the wireless device and the network authenticator

19. The system of claim 18 wherein the RAN uses protocols compatible with the Institute of Electrical and Electronic Engineers (IEEE) 802.16-2005 standard.

20. The system of claim 12 wherein hotlining to the provisioning server is trigged by activity by the wireless device.
